(19) United States
(12) Patent Application Publication
(10) Pub. No.: US 2003/0231746 A1
(43) Pub. Date: Dec. 18, 2003

(54) Teleconference speaker identification

(76) Inventors: Karla Rae Hunter, Naperville, IL (US); Ronald Bruce Martin, Carol Stream, IL (US)

Correspondence Address: Lucent Technologies Inc., Docket Administrator (Room 3J-219), 101 Crawfords Corner Road, Holmdel, NJ, 07733-3030, US

(21) Appl. No.: 10/172,672

(22) Filed: Jun. 14, 2002

(51) Int. Cl. H04M 1/64; H04M 3/42

(52) U.S. Cl. 379/88.01; 379/202.01

(57) ABSTRACT

The present invention provides a method to allow conference call participants to determine the identity of the current speaker without interrupting the call by verbally requesting the identity of the speaker. When a conference call is established, a conference bridge initiates a connection to an Automatic Speech Recognition (ASR) system. The conference bridge prompts each participant as they join the call to repeat words on a predetermined list. The repeated words are sent to the ASR system, where a voice profile is generated for each conference participant. When a conference participant wishes to know the identity of the current speaker, the participant notifies the conference bridge. The conference bridge sends the request to the ASR system, where a comparison is made between the voice of the current speaker and the voice templates. When a match is found, the identity of the current speaker is returned to the requesting participant.

### FIELD OF THE INVENTION

This invention relates generally to the field of conference bridges in communication systems, and more particularly to automatically identifying who is speaking at a given time.

### BACKGROUND OF THE INVENTION

Existing conference bridges allow a plurality of users to call a predetermined telephone number and be bridged together in a conference call. The conference bridge provides a certain amount of information to the conference participants, such as tones when parties join or leave the conference.

There is, however, no current way for conference participants to determine who is speaking at a given time. Participants wishing to know the identity of the current speaker must now interrupt the conference and verbally ask who is speaking.

Therefore, a need exists for a method and apparatus that allows conference participants to identify who is currently speaking.

### BRIEF SUMMARY OF THE INVENTION

The present invention provides a method for providing identification of the current speaker in a conference call. In an exemplary embodiment of the present invention, a conference participant who wishes to know the identity of the current speaker requests the information of the network and the speaker identity is only provided to the requesting participant.

In accordance with an exemplary embodiment of the present invention, when a conference is initiated, the conference bridge includes an Automatic Speech Recognition (ASR) system on the call. As each participant joins the conference call, they are prompted to repeat a predetermined list of words. The ASR system then uses the spoken words to generate a voice template for each conference participant. When a particular participant wishes to learn the identity of the current speaker, the participant signals the conference bridge, which in turn obtains the identity of the speaker from the ASR system and returns the identity to the requesting user.

Advantageously, such an arrangement gives conference participants the ability to learn the identity of the person currently speaking on a conference call without interrupting the call by verbally requesting the speaker's identity.

### BRIEF DESCRIPTION OF THE SEVERAL VIEWS OF THE DRAWINGS

FIG. 1 depicts a communication system in accordance with an exemplary embodiment of the present invention.

FIG. 2 depicts a flow chart of a method for providing teleconference speaker identification during call establishment and voice profile generation in accordance with an exemplary embodiment of the present invention.

FIG. 3 depicts a flow chart of a method for providing teleconference speaker identification when a conference participant requests the identity of the current speaker in accordance with an exemplary embodiment of the present invention.

### DETAILED DESCRIPTION OF THE INVENTION

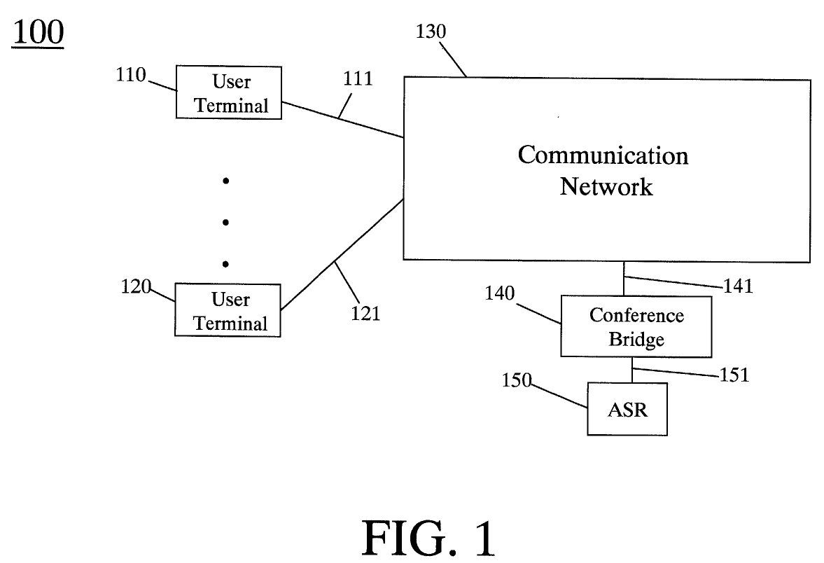

FIG. 1 depicts a communication system 100 in accordance with an exemplary embodiment of the present invention. Communication system 100 includes user terminals 110 and 120 as well as communications network 130, conference bridge 140, and Automatic Speech Recognition (ASR) system 150. Communication network 130 comprises known functions necessary to operate and maintain communications. Communication network 130 can be based on any well known technologies such as analog, digital, wireless, or wireline. For example, communication network 130 can be a Public Switched Telephone Network (PSTN), analog wireless (AMPS) or wireless digital (TDMA or CDMA) system.

User terminals 110 and 120 are coupled to communications network 130 via links 111 and 121 and provide communications among a plurality of user terminals such as 110 and 120. User terminals 110 and 120, as well as links 111, 121, 141, and 151, can be based on any well-known technologies such as analog, digital, wireless, or wireline. It should be understood that communication system 100 can include a plurality of elements and user terminals. Only a single block of communication network elements 160, two user terminals 110 and 120, single conference bridge 140, and single Automatic Speech Recognition (ASR) system 150 are depicted in FIG. 1 for clarity.

In the embodiment depicted in FIG. 1, user terminal 110 and user terminal 120 are coupled to and communicating with communication network 130. It should be understood that in an actual network a plurality of user terminals are coupled to communication network 130. Only two user terminals are depicted in FIG. 1 for clarity. As depicted in FIG. 1 user terminal 110 is communicating with communication network 130 via link 111. User terminal 120 is communicating with communication network 130 via link 121. Links 111 and 121 can be the same or different.

In the embodiment depicted in FIG. 1, conference bridge 140 is coupled to and communicating with communication network 130 via link 141. Link 141 can be an analog link or any other link that can support both user information and control signals. It should be understood that in an actual network a plurality of conference bridges are coupled to the communication network. Only one conference bridge is depicted in FIG. 1 for clarity.

In the embodiment depicted in FIG. 1, ASR system 150 is coupled to and communicating with conference bridge 140 via link 151. Link 151 can be an analog link or any other link that can support both user information and control signals. It should be understood that in an actual network a plurality of ASR systems can be connected to a conference bridge. Only one ASR system is depicted in FIG. 1 for clarity.

In an exemplary embodiment of the present invention, conference bridge 140 receives a call request from a user terminal. The call request can originate from a terminal connected to communication network 130 or from any other network that can interface with communication network 130, such as a PSTN. Conference bridge 140 accepts the call and initiates a session with ASR system 150 via link 151.

Conference bridge 140 plays a list of predetermined words to the call originator and prompts the originator to identify themselves and to repeat the words on the predetermined list. The words as they are spoken as well as the identification of the user are passed to the ASR system 150, where a voice template is generated and associated with the identity of each user.

When a user wishes to determine who is speaking at a given time, the user signals conference bridge 140 via user terminal 110. The signaling can be done in a variety of ways including but not limited to analog signals or digital signals. Conference bridge 140 intercepts the user signal and passes it to ASR system 150. ASR system 150 compares the voice of the current speaker to the plurality of voice templates and identifies the current speaker. ASR system 150 then sends the identity of the speaker to conference bridge 140. Conference bridge 140 provides the identity of the current speaker to the user requesting the speaker's identity. The provision of the speaker identity to the requesting user can be accomplished in a variety of ways, including but not being limited to analog means or digital means.

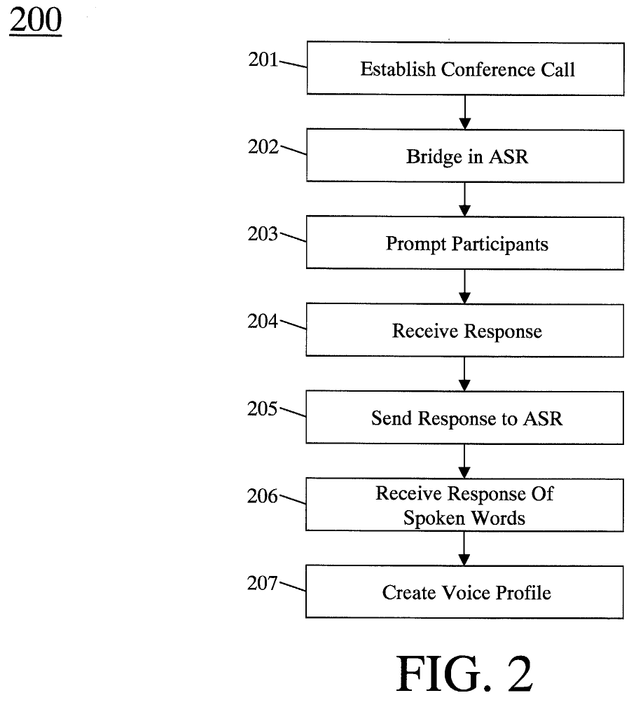

FIG. 2 depicts a flow chart 200 for providing teleconference speaker identification during call establishment and voice profile generation in accordance with an exemplary embodiment of the present invention.

Responsive to incoming call requests, conference bridge 140 establishes (201) a conference call. The method for establishing a conference call is known and typically comprises dialing a predetermined bridge number and entering an predetermined conference identification code.

Conference bridge 140 initiates (202) a session with ASR system 150 by establishing a connection with ASR 150. ASR 150 is also bridged in conference bridge 140 to the conference participants.

Conference bridge 140 prompts (203) participants to repeat a predetermined list of words. This can be done by playing the list of words to the conference participants. This is preferably done on a per participant basis. The words are chosen to have the speaker use a variety of verbal attributes, such as phoneme, tone, inflection, and the like. The method for choosing suitable words is known in the field of speech recognition.

Conference bridge 140 receives (204) the predetermined words spoken by each participant and a spoken identification of each participant. In a preferred embodiment of the present invention, conference bridge 140 blocks the links to the other conference participants so that participants do not hear other participants recite the predetermined list of words.

Conference bridge 140 sends (205) the spoken list of predetermined words and the spoken identification to ASR 150. This can be done as audio voice or data.

ASR system 150 receives (206) the spoken words and spoken identification of the participant. ASR system 150 stores the spoken identification in a manner easily transmitted when requested by a conference participant. Storing the identification as analog data or digitally encoded data are two examples.

ASR system 150 creates (207) a voice profile for each of the conference participants. This comprises analyzing each spoken word and distilling phonemes which are unique characteristics of each speaker. This creation process is currently known in the art of speech recognition.

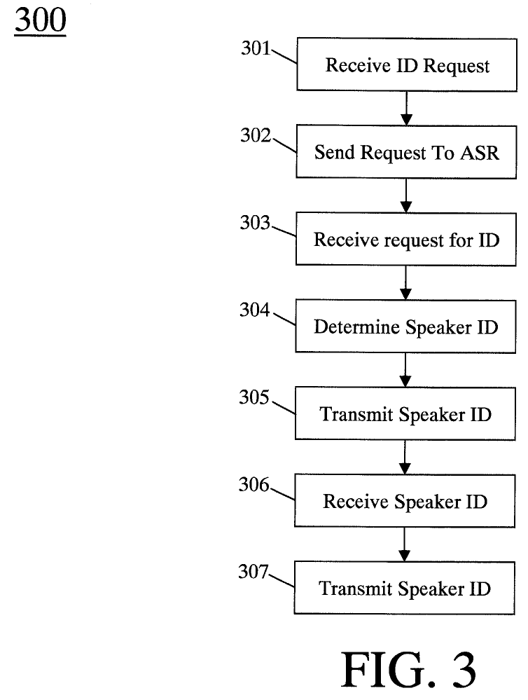

FIG. 3 depicts a flow chart 300 of a method for providing teleconference speaker identification when a conference participant requests the identity of the current speaker in accordance with an exemplary embodiment of the present invention.

Conference bridge 140 receives (301) a speaker identification request from one of the conference participants at a user terminal. There are a variety of ways for the request to be sent to conference bridge 140, including but not limited to utilizing inband tones or out-of-band messaging.

Conference bridge 140 sends (302) the speaker identification request to ASR system 150. Conference bridge 140 prevents transmission of the request to participants other than ASR system 150. This can be accomplished by conference bridge 140 detecting and removing from the voice path the request before the request is bridged to the other participants. There are a variety of ways for the request to be sent to ASR system 150, including but not limited to utilizing inband tones or out-of-band messaging.

ASR system 150 receives (303) the request for speaker identification. There are a variety of ways for the request to be received by ASR system 150, including but not limited to using inband tones or out-of-band messaging.

ASR system 150 determines (304) the identity of the participant currently speaking. This determination comprises distilling the voice of the current speaker into phonemes and comparing them to the predetermined set of voice templates for the conference participants.

ASR system 150 transmits (305) the identity of the participant currently speaking to conference bridge 140. There are a variety of ways for the identity to be transmitted by ASR system 150, including but not limited to inband identification such as playing a recording of the name of the current speaker and out-of-band messaging.

Conference bridge 140 receives (306) the identification of the current speaker from ASR system 150. There are a variety of ways for the identity to be received by conference bridge 140, including but not limited to using inband audio and out-of-band messaging.

Conference bridge 140 transmits (307) the identification of the current speaker to the requesting user terminal. There are a variety of ways for the identity to be transmitted by conference bridge 140, including but not limited to using inband audio or out-of-band messaging.

The present invention thereby provides a method for providing identification of the current speaker during a conference call. By using the present invention, the user can identify the person currently speaking without interrupting the conference call and verbally asking the speaker to identify themselves.

While this invention has been described in terms of certain examples thereof, it is not intended that it be limited to the above description, but rather only to the extent set forth in the claims that follow.

We claim:

1. A method of providing teleconference speaker identification in a communication system, the method comprising the steps of:
establishing a conference call including a plurality of users at a conference bridge;
bridging an Automatic Speech Recognition System (ASR) onto the conference call;
prompting each of the plurality of users to speak predetermined words;
receiving spoken words in response to the prompting; and
sending the spoken words to the ASR.

2. A method of providing teleconference speaker identification in accordance with claim 1, wherein the step of prompting each of the plurality of users to speak predetermined words comprises playing a list of words for each of the plurality of users to repeat.

3. A method of providing teleconference speaker identification in accordance with claim 1, wherein the step of prompting each of the plurality of users to speak predetermined words comprises requesting each of the plurality of users to identify themselves.

4. A method of providing teleconference speaker identification in a communication system, the method comprising the steps of:
accepting a request for speaker identification from a requesting user at a conference bridge;
transmitting the request for speaker identification to an Automatic Speech Recognition (ASR) system;
accepting speaker identification from the ASR system; and
transmitting speaker identification to the requesting user.

5. A method of providing teleconference speaker identification in accordance with claim 4, the method further comprising the step of blocking the request for speaker identification from being transmitted to all parties on the conference bridge.

6. A method of providing teleconference speaker identification in accordance with claim 4, wherein the step of transmitting the requests for speaker identification to the ASR system comprises sending a message from the conference bridge to the ASR system.

7. A method of providing teleconference speaker identification in accordance with claim 4, wherein the step of accepting speaker identification from the ASR system comprises receiving a message at the conference bridge from the ASR system.

8. A method of providing teleconference speaker identification in accordance with claim 4, wherein the step of transmitting speaker identification comprises transmitting speaker identification via analog signals.

9. A method of providing teleconference speaker identification in accordance with claim 4, wherein the step of transmitting speaker identification comprises transmitting speaker identification via data packets.

10. A method of providing teleconference speaker identification in accordance with claim 4, wherein the step of transmitting speaker identification comprises transmitting speaker identification via a multimedia stream.

11. A method of providing teleconference speaker identification in accordance with claim 4, wherein the step of transmitting speaker identification comprises sending a message including speaker identification to a user terminal associated with the requesting user.

12. A method of providing teleconference speaker identification in accordance with claim 4, wherein the step of transmitting speaker identification comprises connecting the ASR system to a conference port of the requesting user.

13. A method of providing teleconference speaker identification in a communication system in accordance with claim 4, further comprising releasing conference ports at the conclusion of the call at the conference bridge.

14. A method of providing teleconference speaker identification in a communication system, the method comprising the steps of:
establishing a voice profile for each user in a conference call in an Automatic Speech Recognition (ASR) system;
accepting a request for speaker identification of the current speaker from a requesting user; and
sending speaker identification to the requesting user.

15. A method of providing teleconference speaker identification in accordance with claim 14, wherein the step of receiving voice profile information comprises receiving predetermined words spoken by each user.

16. A method of providing teleconference speaker identification in accordance with claim 15, further comprising the step of generating a voice template for each user on the conference call.

17. A method of providing teleconference speaker identification in accordance with claim 16, further comprising the step of associating a user identification with the voice template.

18. A method of providing teleconference speaker identification in accordance with claim 14, further comprising the step of determining speaker identification.

19. A method of providing teleconference speaker identification in accordance with claim 14, wherein the step of sending speaker identification to the requesting user comprises transmitting a message including a user identification to the conference bridge.

20. A method of providing teleconference speaker identification in accordance with claim 14, wherein the step of sending speaker identification to the requesting user comprises playing an audio identification of the teleconference speaker over a voice path to the conference bridge.
